(19) United States
(12) Patent Application Publication
(10) Pub. No.: US 2015/0344158 A1
(43) Pub. Date: Dec. 3, 2015

(54) SPACE AIRCRAFT

(71) Applicant: AIRBUS DEFENCE AND SPACE SAS, Les Mureaux (FR)

(72) Inventors: Eugénio Ferreira, Toulouse (FR); Marco Prampolini, Chambourcy (FR); Yohann Coraboeuf, Merignac (FR)

(73) Assignee: AIRBUS DEFENCE AND SPACE SAS, Les Mureaux (FR)

(21) Appl. No.: 14/763,299

(22) PCT Filed: Jan. 17, 2014
(86) PCT No.: PCT/FR2014/000009

§ 371 Date: Jul. 24, 2015

(30) Foreign Application Priority Data
Feb. 6, 2013 (FR) 13/00242

(51) Int. Cl. B64G 1/40; B64G 1/14

(52) U.S. Cl. CPC B64G 1/40; B64G 1/14

(57) ABSTRACT

According to the invention, said space aircraft comprises, at the front of each of the air inlets of the turbo engines, a mobile flap that can move, in both directions, between a first position for which said flap opens said air inlet and a second position for which said flap prevents air from entering said air inlet.

### FIELD

The present invention relates generally to a space aircraft capable of taking off from the ground in the usual manner, reaching an altitude of at least a hundred kilometres, flying at a transonic or even supersonic speed, and then landing in the usual manner of an aircraft.

### BACKGROUND

Single-storey space aircraft capable of flying at speeds of greater than 0.9 mach, comprise both anaerobic propulsion means such as rocket motors, and aerobic propulsion means such as turboshaft engines.

During the flight of a space aircraft of this kind, it is possible for just the anaerobic propulsion means to be operating, the aerobic propulsion means then being inactive or switched off. In such a stage of flight, air entry of the aerobic propulsion means thus causes significant drag, braking the flight of the space aircraft.

### SUMMARY

The object of the present invention is to remedy this drawback, among others. For this purpose, according to an embodiment of the invention, the single-storey space aircraft, which is capable of flying at speeds of greater than 0.9 mach and which comprises:
anaerobic propulsion means and
aerobic propulsion means, which are provided with at least one air entry.

The aircraft also comprises at least one movable flap which is mounted on the framework of the space aircraft, in front of the air entry, and which can move, in both directions, between a first position for which the movable flap clears the air entry and is applied against the fuselage of the space aircraft, and a second position for which the movable flap covers the air entry from the aerodynamic flow around the space aircraft, preventing air from penetrating into the air entry.

Thus, by means of a movable flap of this kind, the air entry can be isolated from the airflow around the aircraft, such that the drag thereof can be reduced, when the aerobic propulsion means are not operating. It will be noted in addition that, by means of the movable flap, the aerobic propulsion means are thus protected from excessive gas speeds and the resulting heating.

Although the movable flap arrangement may move in different ways, it is advantageous for it to rotate between the first and second positions.

In one embodiment the single flap is domed to allow it to fit the shape of the fuselage when it occupies the first retracted position. Moreover, the single flap in one embodiment is rounded opposite the air entry so as to further reduce the drag of the assembly of the flap and the air entry in the second extended position.

### BRIEF DESCRIPTION OF THE DRAWINGS

The accompanying drawings make it possible to understand how the invention can be represented. In said drawings, identical reference numerals denote like elements.

FIG. 1 is a perspective view of a space aircraft according to an aspect of the present invention, equipped with flaps for covering the air entry, which flaps are in the retracted position, clearing the air entries of the turboshaft engine.

FIG. 2 is a further perspective view of the space aircraft from FIG. 1, with said flaps in the extended position, covering the air entries of the turboshaft engines.

FIGS. 3 and 4 show the operating mechanism of a covering flap of the space aircraft from FIGS. 1 and 2.

### DETAILED DESCRIPTION

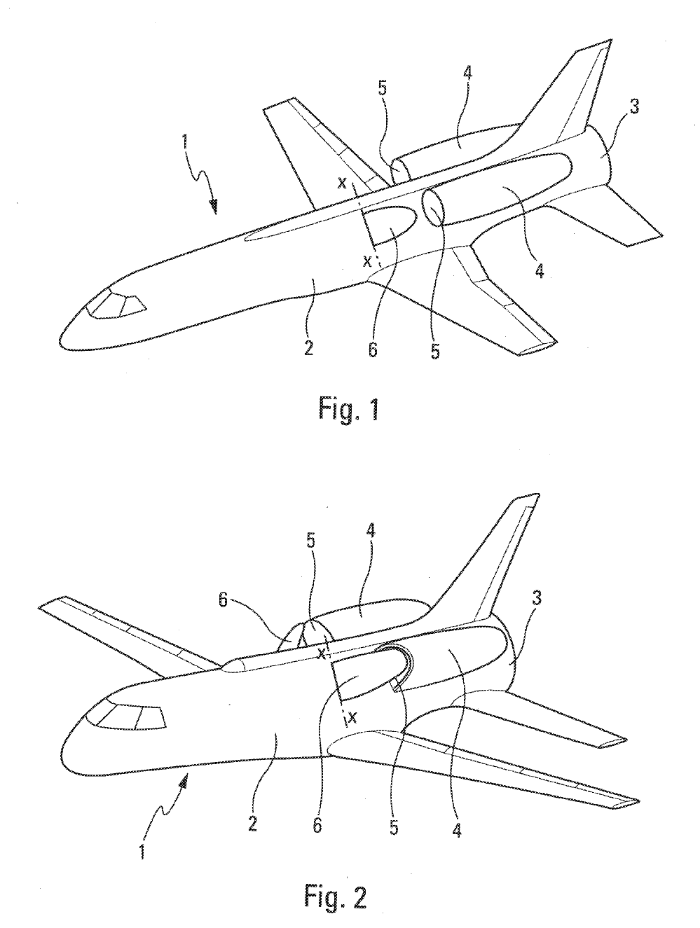

The space aircraft 1 according to an aspect of the present invention and shown in FIGS. 1 and 2 comprises just one storey, having a fuselage 2, and is capable of transonic and/or supersonic flight.

The space aircraft 1 comprises at least one rocket motor 3 and two turboshaft engines 4, each comprising an air entry 5. The turboshaft engines are laterally arranged at the rear of the fuselage 2, such that one of the turboshaft engines 4 is on the left and the other of said turboshaft engines 4 is on the right of the fuselage 2.

When the space aircraft is in transonic or supersonic flight and the turboshaft engines 4 are not operating, the air entries 5 are the source of significant aerodynamic drag.

Thus, in order to remedy this drawback, the space aircraft 1 from FIGS. 1 and 2 comprises, in front of each of the two air entries 5, a rotating flap 6, which is articulated about an axis X-X of the framework of the space aircraft. Each flap 6 can move, in both directions, between a retracted position (see FIG. 1) for which it is applied against the fuselage 2 and clears the corresponding air entry 5, and an extended position (see FIG. 2) for which it covers said air entry 5 from the aerodynamic flow around said space aircraft.

Thus, when the space aircraft 1 is at high speed and the turboshaft engines 4 are not operating, the air entries 5 of the engines can be covered by the flaps 6 so as to reduce the aerodynamic drag of the air entries 5.

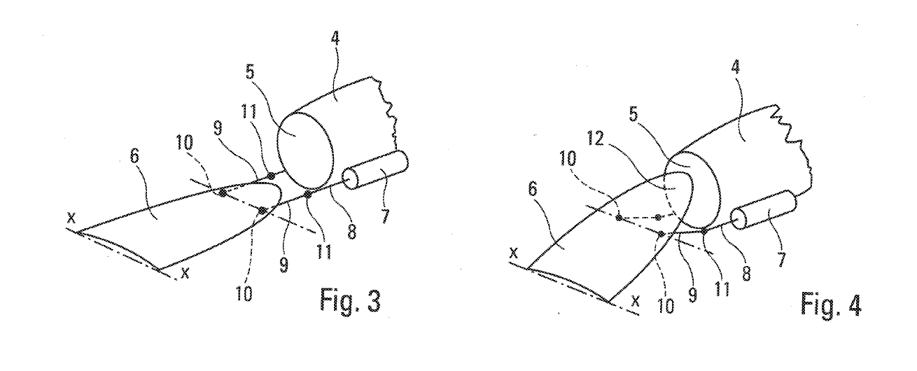

In order to actuate the flaps 6 between the retracted position thereof and the extended position thereof, and vice versa, the system shown schematically in FIGS. 3 and 4, comprising actuators 7, can be used. The rod 8 of each actuator 7 is connected to the corresponding flap 6 by means of a connecting rod 9 articulated, on one side, to the flap 6 by means of a hinged joint 10 and, on the other side, to the actuator rod 8 by means of a swing joint 11.

Each flap 6 is domed so as to be able to fit the shape of the fuselage 2 in the retracted position (FIG. 1). Moreover, in order to reduce the drag which flap may cause in the extended position (FIG. 2), the end 12 thereof which is opposite the corresponding air entry 5 is rounded.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. Single-storey space aircraft, which is capable of flying at speeds of greater than 0.9 mach, the aircraft comprising:
anaerobic propulsion means;
aerobic propulsion means, which are provided with at least one air entry;
at least one movable flap mounted on a framework of the aircraft, in front of said air entry, and which can move, in both directions, between a first position for which said movable flap clears said air entry and is applied against a fuselage of said aircraft, and a second position for which said movable flap covers said air entry from the aerodynamic flow around said aircraft, preventing air from penetrating into said air entry.

2. Aircraft according to claim 1,
wherein said movable flap rotates between said first and second positions.

3. Aircraft according to claim 1,
wherein said movable flap is domed to allow it to fit the shape of said fuselage when it occupies said first position.

4. Aircraft according to claim 1,
wherein said movable flap is rounded opposite said air entry.
